(19) United States
(12) Patent Application Publication
(10) Pub. No.: US 2023/0329158 A1
(43) Pub. Date: Oct. 19, 2023

(54) METHOD FOR CONSTRUCTING FLOWERBED BOUNDARY BY USING BOUNDARY PLATE

(71) Applicants: Do-Hoon KIM, Gyeongsangnam-do (KR); Seung Bong LEE, Daegu (KR)

(72) Inventors: Do-Hoon KIM, Gyeongsangnam-do (KR); Seung Bong LEE, Daegu (KR)

(21) Appl. No.: 18/028,757

(22) PCT Filed: Oct. 14, 2021
(86) PCT No.: PCT/KR2021/014265

§ 371 Date: Mar. 28, 2023

(30) Foreign Application Priority Data
Oct. 16, 2020 (KR) 10-2020-0133876

(51) Int. Cl. A01G 9/28

(52) U.S. Cl. CPC A01G 9/28

(57) ABSTRACT

Proposed is a method for constructing a flowerbed boundary surface by using a boundary plate in which prefabricated members are used and only installation thereof is performed at a site so as to enable the fast construction of the flowerbed boundary surface. The method for constructing a flowerbed boundary surface includes a preparation step of preparing necessary members according to a drawing of the flowerbed boundary surface to be installed, a curved-surface processing step of processing members, which require curved-surface processing, to have curved surfaces among the members prepared through the preparation step, a temporary assembly step of temporarily assembling the flowerbed boundary surface by using all of the members, a painting step of performing necessary painting of each of the members, and an on-site installation step of installing all of the members on a site after transporting all of the members to the site.

### TECHNICAL FIELD

The present disclosure relates to a method for constructing a flowerbed boundary surface by using a boundary plate and, more particularly, to a method for constructing a flowerbed boundary surface by using a boundary plate, in which the rapid construction of the flowerbed boundary surface can be performed by using a metal boundary plate.

### BACKGROUND ART

A flowerbed is a place for planting flowers or trees, and is mainly built in parks, squares, roadsides, schools and amusement parks, and private houses. Generally, a flowerbed includes boundary stones or fences installed on the edge of the flowerbed so as to be distinguished from parts other than the flowerbed.

It is preferable that the fences or boundary stones as described above are manufactured in consideration of beauty of the flowerbed so as to meet the purpose of the flowerbed.

In addition, in order to form the flowerbed, it is common to stack soil higher than the surface of the earth.

In the above case, the boundary stones function as the boundary of the flowerbed or function to prevent soil from flowing down and being lost due to running water, together with an aesthetic function. The boundary stones have appropriate heights and are required to be arranged to be in close contact with each other.

To this end, in the past, landscape stones of predetermined sizes or more were collected and stacked on the periphery of a flowerbed and were used as boundary stones for a flowerbed to prevent the loss of soil. However, due to the collection of stones, the environment is easily damaged, and further, the number of landscape stones that can be collected is also limited.

To overcome the problems as described above, there is proposed a method in which artificial stones produced in such a manner that materials such as cement, plaster, and stone powder are mixed with water, are put in a predetermined mold, and are dried are used as boundary stones for a flowerbed. Boundary stones manufactured in such a method as described above have consistent shapes and are easy to be stacked up, and it is possible to repeatedly form a pattern of a desired shape on each of the surfaces of the boundary stones.

When disposing or stacking the above conventional artificial flowerbed boundary stones along the periphery of the flowerbed, to prevent the loss or falling down of the boundary stones, a method in which adhesive means such as cement mortar are used to bond the boundary stones to each other may be used, and further, a method in which a boundary stone having length and size required for an entire site is constructed may be used.

In addition, configurations of boundary stones with special functions have also been proposed. For example, Korean Utility model Application Publication No. 20-2013-0005332 discloses a boundary stone configured to prevent soil or fallen leaves from accumulating on a sidewalk beyond the boundary stone in the event of rain or accumulation of the fallen leaves since a flowerbed is higher than a sidewalk, wherein the boundary stone has a bump made at one side of an upper part of a boundary stone body made in the form of a block so that the soil or fallen leaves are prevented from easily overflowing toward the sidewalk.

Meanwhile, recently, there are many cases in which steel is used instead of stone to construct a boundary of a flowerbed. Particularly, in the case of installing a flowerbed on the roof of a building, the boundary part is constructed by using relatively light steel instead of stone.

Particularly, when constructing a steel boundary surface, it is common that a pipe or iron plate is prepared, is partially bent, cut, and painted at a site so that the entirety of the boundary surface is constructed. As for the above construction method, the construction of the boundary surface is performed while the boundary surface is exposed to external environment, and thus is sensitive to the change of the environment of the site, thereby giving difficulty to establishment of an accurate construction plan and having a large range of variation in quality depending on the skill of a worker due to much site work.

### DISCLOSURE

### Technical Problem

The present disclosure has been made to overcome the above problems of a conventional construction method, and is intended to propose a method for constructing a flowerbed boundary surface by using a boundary plate in which prefabricated members are used and only installation thereof is performed at a site so as to enable the fast construction of the flowerbed boundary surface.

### Technical Solution

In order to accomplish the above objective, the present disclosure provides a method for constructing a flowerbed boundary surface by using a boundary plate, the method including: a preparation step of preparing necessary members according to a drawing of a flowerbed boundary surface to be installed; a curved-surface processing step of processing members, which require curved-surface processing, to have curved surfaces among the members prepared through the preparation step; a temporary assembly step of temporarily assembling the flowerbed boundary surface by using all of the members; a painting step of performing necessary painting of each of the members; and an on-site installation step of installing all of the members on a site after transporting all of the members to the site.

Preferably, the members prepared at the preparation step may include a plurality of boundary plates, a plurality of support parts, and a plurality of fixing parts.

More preferably, each of the boundary plates may include: an outer wall part; a side wall part formed by being bent on each of opposite ends of the outer wall par; and a plurality of holes formed in the outer wall part and the side wall part, respectively, each of the support parts may include: a support-part body; a bottom part bent perpendicularly to one end of the support-part body; and a plurality of holes formed in the support-part body and the bottom part, respectively, and each of the fixing parts may include: a fixing part body and a plurality of holes formed in the fixing part body.

Preferably, the members prepared at the preparation step may further include a bench top plate and a bench fixing part, wherein the bench fixing part may include: a body part; a bent part formed on each end of the body part; and holes formed in the bent part.

Preferably, at the curved-surface processing step, the members processed to have curved surfaces may be the plurality of boundary plates.

More preferably, at the temporary assembly step, coupling of all of the members to the ground may be omitted, and by checking whether there is a defective part, an identified defective part may be replaced.

Preferably, at the painting step, after the boundary plates are completely painted, protective films for protecting painted surfaces of the boundary plates may be attached to the boundary plates, respectively.

Preferably, at the on-site installation step, all of the members may be assembled with each other by bolting.

### Advantageous Effects

The method for constructing a flowerbed boundary surface by using a boundary plate according to the present disclosure includes the preparation step, the curved-surface processing step, the temporary assembly step, the painting step, and the on-site installation step, and all members required for installation are manufactured and painted in advance, and thus the installation is completed only by bolting at a site, thereby realizing fast construction time and enabling a flowerbed boundary surface of uniform quality to be constructed.

### DESCRIPTION OF DRAWINGS

FIG. 1 is a flowchart of a method for constructing a flowerbed boundary surface according to the present disclosure,

FIG. 2 is a view illustrating a boundary plate, a support part, and a fixing part prepared in a preparation step of FIG. 1,

FIG. 3 is a view illustrating a bench top plate and a bench fixing part prepared in the preparation step of FIG. 1,

FIG. 4 illustrates an example of the boundary plate processed through a curved-surface processing step of FIG. 1,

FIG. 5 illustrates an embodiment of the flowerbed boundary surface installed according to the flowchart of FIG. 1, and

FIG. 6 illustrates another embodiment of FIG. 5.

### BEST MODE

Hereinafter, some embodiments of the present disclosure will be described in detail through exemplary drawings. In adding reference numerals to components of each drawing, it should be noted that the same components have the same numerals as much as possible, even if the components are displayed on different drawings. In addition, in describing the embodiments of the present disclosure, when it is determined that a detailed description of a related known configuration or function interferes with understanding of the embodiments of the present disclosure, detailed description thereof will be omitted.

In addition, in describing the components of the embodiment of the present disclosure, terms such as first, second, A, B, (a), and (b) may be used. These terms are only used to distinguish components from other components, and the nature, sequence, or order of a corresponding component is not limited by the terms. When a component is described as being “connected” or “coupled” to another component, that component may be directly connected or coupled to the another component, but it should be understood that another component may be “connected” or “coupled” to each of components between the components.

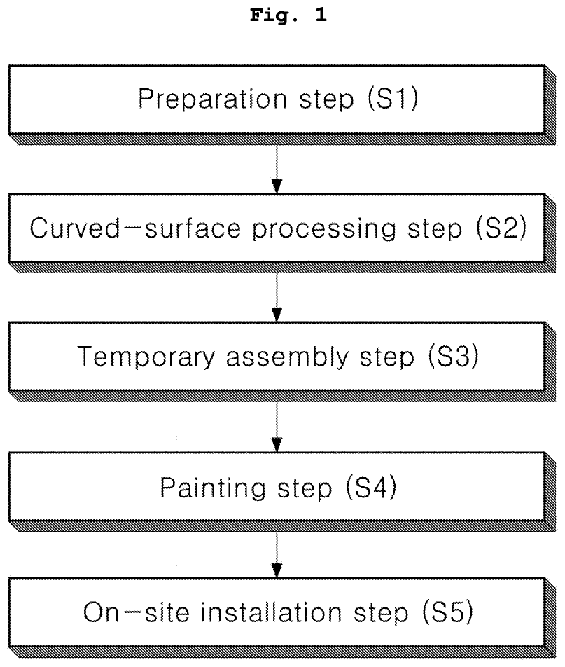

A method for constructing a flowerbed boundary surface by using a boundary plate according to the present disclosure includes a preparation step S1, a curved-surface processing step S2, a temporary assembly step S3, a painting step S4, and an on-site installation step S5 as illustrated in FIG. 1.

Hereinafter, each of the steps will be described in detail.

Preparation Step S1

In the preparation step S1, through the drawing of the flowerbed boundary surface which is required to be installed at a site, as many boundary plates 10, support parts 20, fixing parts 30, bench top plates 40, and bench fixing parts 50 are prepared as needed.

Of course, on a boundary surface on which a bench is not installed, the preparation of the bench top plate 40 and the bench fixing part 50 may be omitted.

Here, each of the boundary plates 10, support parts 20, fixing parts 30, and bench fixing parts 50 is manufactured by bending a metal material, particularly, a steel plate, and each of the bench top plates 40 is manufactured of wood or plastic and is fixed to the boundary plate 10 by the bench fixing part 50.

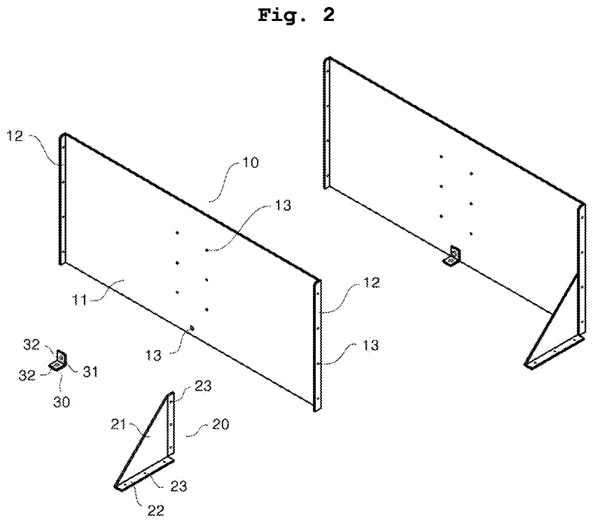

The members will be described in detail. As illustrated in FIG. 2, the boundary plate 10 is manufactured by bending a steel plate, and includes an outer wall part 11 and a side wall part 12 formed by being bent perpendicularly to each end of the outer wall part 11.

In addition, a hole 13 into which a bolt is inserted is formed in the lower end of the outer wall part 11 so as to fix the fixing part 30 thereto, and when required, multiple holes 13 in which inserted bolts are received are formed in the upper half portion of the outer wall part 11 so as to fix the bench fixing part 50 thereto.

Of course, when the length of the outer wall part 11 is relatively short and when the bench fixing part 50 is not fixed, the formation of the holes 13 may be omitted.

The side wall part 12 has multiple holes 13, and the multiple holes 13 are configured so that the side wall part 12 is bolted to a neighboring side wall part 12, and the bolt is, of course, fixed by a nut.

The boundary plate 10 is initially manufactured in the shape of a flat plate.

Meanwhile, the support part 20 includes a triangle-shaped support-part body 21 and a bottom part 22 bent perpendicularly to the bottom of the support-part body 21. The support-part body 21 has a plurality of holes 23 so that the support-part body 21 is coupled to the side wall part 12, and the bottom part 22 has a plurality of holes 23 for the coupling of anchor bolts.

Meanwhile, in the fixing part 30, a fixing part body 31 bent in the form of an “L” has holes 32 so that each bottom of the fixing part body is coupled to the outer wall part 11.

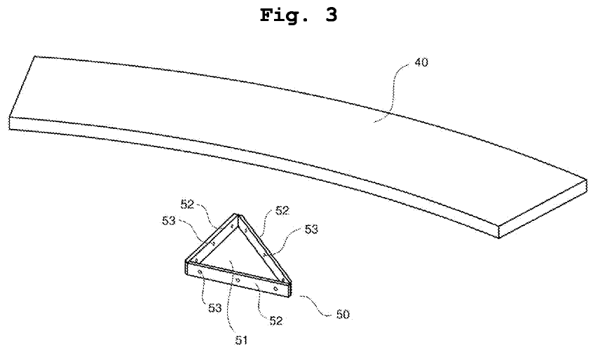

Meanwhile, as illustrated in FIG. 3, the bench fixing part 50 includes a triangle-shaped body part 51 and a bent part 52 bent perpendicularly to each end of the body part 51, wherein the bent part 52 has multiple holes 53 so that the bent parts 52 are coupled to other members.

The bench top plate 40 is seated on the upper end of the bench fixing part 50 and has coupling holes formed in the lower surface of the bench top plate 40 so that the bench top plate 40 is coupled to the bench fixing part 50.

The bench top plate 40 may be formed in an arc-shaped plate but may be formed in the shape of a flat plate when required.

Curved-Surface Processing Step S2

The curved-surface processing step S2 is a step at which the boundary plate 10 prepared through the preparation step S1 is processed in the form of a curved surface.

The boundary plate 10 includes a plurality of boundary plates, and among the plurality of boundary plates, a boundary plate 10 requiring a curved surface is processed to have a curved surface from a flat surface, which is performed by a curved-surface processing device which can process a flat plate into a curved plate.

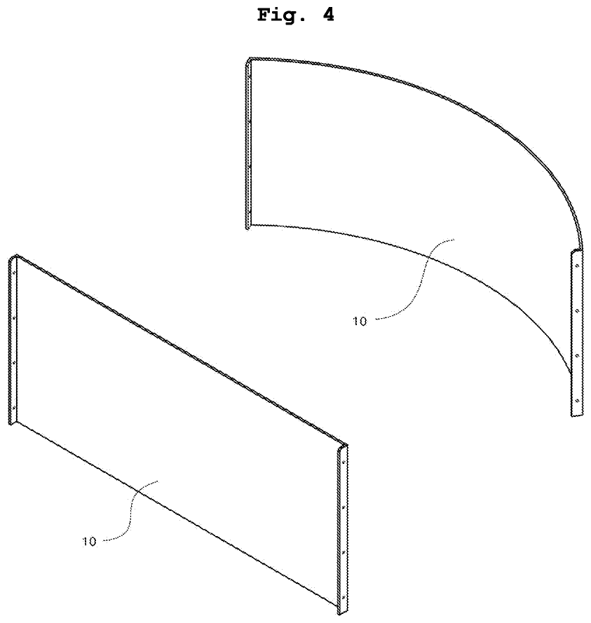

In the above step, as illustrated in FIG. 4, the boundary plate 10 in the form of a flat plate is processed into the boundary plate 10 in the form of a curved surface.

Temporary Assembly Step S3

The temporary assembly step S3 is a step at which the temporary assembly of the members manufactured through the curved-surface processing step S2 is performed before the members are installed at a site.

In the temporary assembly, all of the members are preferably coupled to each other, and the coupling of the members to the ground is omitted. The temporary assembly is preferably performed indoors, such as a factory, but may be performed outside when required.

In addition, when required for rapid progress, the temporary assembly may be performed by only the combination of the boundary plate 10 with the support part 20 by bolting.

Furthermore, when required, only the assembly of the boundary plate 10, the support part 20, the bench top plate 40, and the bench fixing part 50 with each other may be performed to be installed. In the temporary assembly, the coupling of the fixing part 30, which is a component coupled to the ground, may be omitted.

After it is checked whether the entire shape of the boundary surface formed through the temporary assembly has the same shape as illustrated in a design drawing, some defective members are replaced.

Painting Step S4

The painting step S4 is a step at which members which are completely manufactured through the temporary assembly step S3 are painted in a color required by the drawing, and is performed in a painting factory.

Temporary protective films may be attached respectively to members which have been completely painted so that the surfaces of the members are prevented from being contaminated.

Particularly, since the painting of all members is performed indoors, defective painting which may occur during painting the members outside may be prevented in advance. When required, each member may be painted in a different color, the flowerbed boundary surface having different colors may be formed.

On-Site Installation Step S5

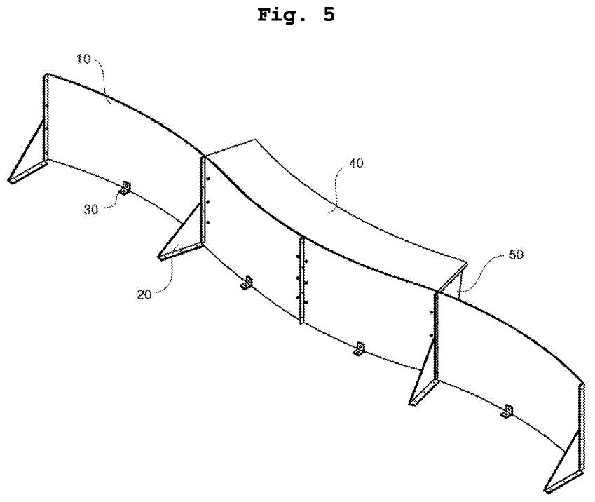

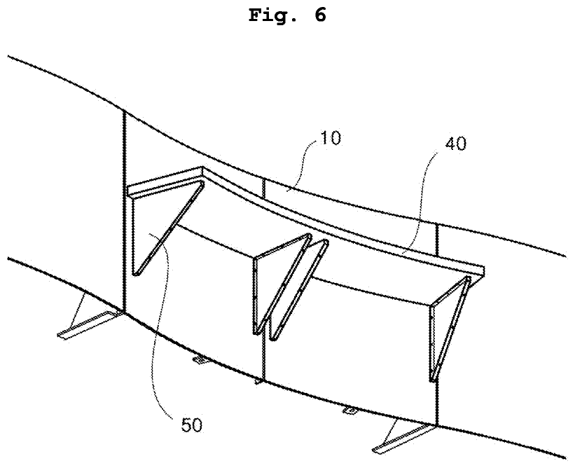

The on-site installation step S5 is a step at which all members which are completely painted through the painting step S4, and bolts and nuts for assembly are transported to a site and are installed in such a shape as illustrated in each of FIGS. 5 and 6.

In this case, after removing the temporary protective films attached after the painting, the boundary plate 10, the support part 20, and the fixing part 30 are connected to each other to be arranged and are coupled to each other by using bolts and nuts.

In addition, by using anchor bolts installed on the ground, the support part 20 and the fixing part 30 are fixed to the ground.

Next, when the bench top plate 40 is seated on and fixed to the upper end of the boundary plate 10 after the bench fixing part 50 is fixed to the boundary plate 10 by using bolts and nuts, the entire installation of the flowerbed boundary surface is completed.

Of course, the above order may be changed when required. For example, after the support part 20 and the fixing part 30 are fixed to the anchor bolts installed on the ground in advance, the assembly of the boundary plates may be performed.

Alternatively, in a case in which the entire size of the boundary surface is large, after assembling multiple partial modules divided according to appropriate sizes, assembled modules are coupled to each other, and thus the entire installation of the boundary surface may be completed.

The above description is about the embodiments for implementing the method for constructing a flowerbed boundary surface by using a boundary plate according to the present disclosure, and the present disclosure is not limited to the above-described embodiments, and those skilled in the art to which the present disclosure belongs may variously modify the embodiments without departing the gist of the present disclosure claimed in the scope of the following claims.

1. A method for constructing a flowerbed boundary surface by using a boundary plate, the method comprising:
a preparation step of preparing necessary members according to a drawing of a flowerbed boundary surface to be installed;
a curved-surface processing step of processing members, which require curved-surface processing, to have curved surfaces among the members prepared through the preparation step;
a temporary assembly step of temporarily assembling the flowerbed boundary surface by using all of the members;
a painting step of performing necessary painting of each of the members; and
an on-site installation step of installing all of the members on a site after transporting all of the members to the site.

2. The method of claim 1, wherein the members prepared at the preparation step comprise a plurality of boundary plates, a plurality of support parts, and a plurality of fixing parts.

3. The method of claim 2, wherein each of the boundary plates comprises: an outer wall part; a side wall part formed by being bent on each of opposite ends of the outer wall par; and a plurality of holes formed in the outer wall part and the side wall part, respectively,
each of the support parts comprises: a support-part body; a bottom part bent perpendicularly to one end of the support-part body; and a plurality of holes formed in the support-part body and the bottom part, respectively, and
each of the fixing parts comprises: a fixing part body and a plurality of holes formed in the fixing part body.

4. The method of claim 2, wherein the members prepared at the preparation step further comprise a bench top plate and a bench fixing part,
wherein the bench fixing part comprises: a body part; a bent part formed on each end of the body part; and holes formed in the bent part.

5. The method of claim 2, wherein at the curved-surface processing step, the members processed to have curved surfaces are the plurality of boundary plates.

6. The method of claim 5, wherein at the temporary assembly step, coupling of all of the members to the ground is omitted, and by checking whether there is a defective part, an identified defective part is replaced.

7. The method of claim 5, wherein at the painting step, after the boundary plates are completely painted, protective films for protecting painted surfaces of the boundary plates are attached to the boundary plates, respectively.

8. The method of claim 5, wherein at the on-site installation step, all of the members are assembled with each other by bolting.
